(19) United States
(12) Patent Application Publication
(10) Pub. No.: US 2009/0243795 A1
(43) Pub. Date: Oct. 1, 2009

(54) AUTOMOTIVE PASSIVE ENTRY SYSTEM AND METHOD OF OPERATING SAME

(75) Inventors: Riad Ghabra, Dearborn Heights, MI (US); Ehab Tarmoom, Allen Park, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 12/056,778

(22) Filed: Mar. 27, 2008

(51) Int. Cl. G05B 19/00

(52) U.S. Cl. 340/5.72

(57) ABSTRACT

A passive start and entry (PASE) system includes a PASE module and a token. The token includes a display. The PASE module generates a low frequency wake-up signal and a high frequency challenge signal for the token in response to a triggering event. The token ignores the wake-up signal if the display is on. The token may turn the display off in response to receiving the low frequency wake-up signal. The token may also turn the display off in response to receiving the high frequency challenge signal.

### BACKGROUND

1. Field of the Invention

The invention relates to automotive passive entry systems and methods of operating the same.

2. Discussion

Certain passive start and entry systems are known. U.S. Patent Publication 2007/0228828 A1 to Ostrander et al. is an example of such a system. Ostrander et al. provides a vehicle passive start and entry system that includes a controller that sends signals through a low frequency antenna to an identification device. The low frequency antenna is disposed within the vehicle cabin and proximate a source that generates extraneous electronic noise that may interfere with the transmission between the passive start and entry system and the identification device.

U.S. Patent Publication 2006/0208854 A1 to Baumgartner et al. is another example of such a system. Baumgartner et al. provides a passive start and entry system that monitors a signal strength of a low frequency signal detected by a fob. The fob reports the signal strength back to an electronic control unit using a radio frequency signal. The electronic control unit compares the signal strength to a predetermined threshold. If the signal strength is below the threshold, the electronic control unit determines that the fob may not be receiving the low frequency transmission due to interference and takes corrective action.

U.S. Patent Publication 2006/0202798 A1 to Baumgartner et al. is yet another example of such a system. Baumgartner et al. provides a passive start and entry system that monitors several radio frequencies to detect a fob signal and for noise at each of the several frequencies. When the system detects noise on the default frequency, another radio frequency channel is selected for communication. A vehicle unit sends a signal to a fob indicating which frequency the fob should use to transmit. The fob resets a radio frequency sender to the selected frequency. At the same time, the vehicle unit resets the radio frequency receiver to receive on that frequency.

European Patent Application EP 1 184 236 A2 of Hara is still yet another example of such a system. Hara provides a stationary device that sends a portable-device finding signal to a portable device from a plurality of stationary-device side antennae, which are located at different positions. Upon receipt of the portable device finding signal from the stationary device, the portable device sends a reception intensity data signal to the stationary device. The stationary device determines the current position of the portable device by using reception intensity data of the portable-device finding signals, which are received at the stationary-device side antennae, from the portable device.

### SUMMARY

A passive entry system for an automotive vehicle includes a control unit being configured to broadcast a wake-up signal at a first frequency to prompt a token to power-up if the token is in a low-power consumption mode. The system also includes a token, including a display, being configured to receive the wake-up signal and to deactivate the display if the display is active in response to receiving the wake-up signal.

A method of operating a token of a passive entry system includes receiving a high frequency challenge signal to validate the token, determining if a display is on and turning the display off in response to receiving the high frequency challenge signal if the display is on.

A method of operating a passive entry system includes generating a display deactivation signal to prompt a token to deactivate a display and generating a wake-up signal to prompt the token to power-up if the token is in a low-power consumption mode.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a block diagram of an exemplary passive start and entry system according to an embodiment of the invention;

FIG. 2 is a flow chart depicting an exemplary communication sequence associated with a passive start and entry system according to an embodiment of the invention; and

FIG. 3 is a flow chart depicting an exemplary communication sequence associated with another passive start and entry system according to an embodiment of the invention.

### DETAILED DESCRIPTION

Passive start and entry (PASE) systems may unlock and start a vehicle without a key. Certain PASE systems communicate an inquiry signal to a token, such as a fob or card, carried by a user. The token, in response, transmits a confirmation signal. Doors of the vehicle may be unlocked and the vehicle may be started when the signal is confirmed. If the token becomes a predetermined distance away from the vehicle, the doors may be locked.

Some tokens may include a display for vehicle information. Information is communicated from the vehicle to the token via wireless signals.

The display is typically on for a configurable duration following a triggering event, such as a button press, a vehicle initiated signal related to an anti-theft event, etc. Display drivers refresh the display when active to maintain any images, text or backlighting. Electromagnetic noise generated by the display and its driver circuitry may affect the ability of the token to accurately measure the field strength of any low frequency signals broadcast by the PASE.

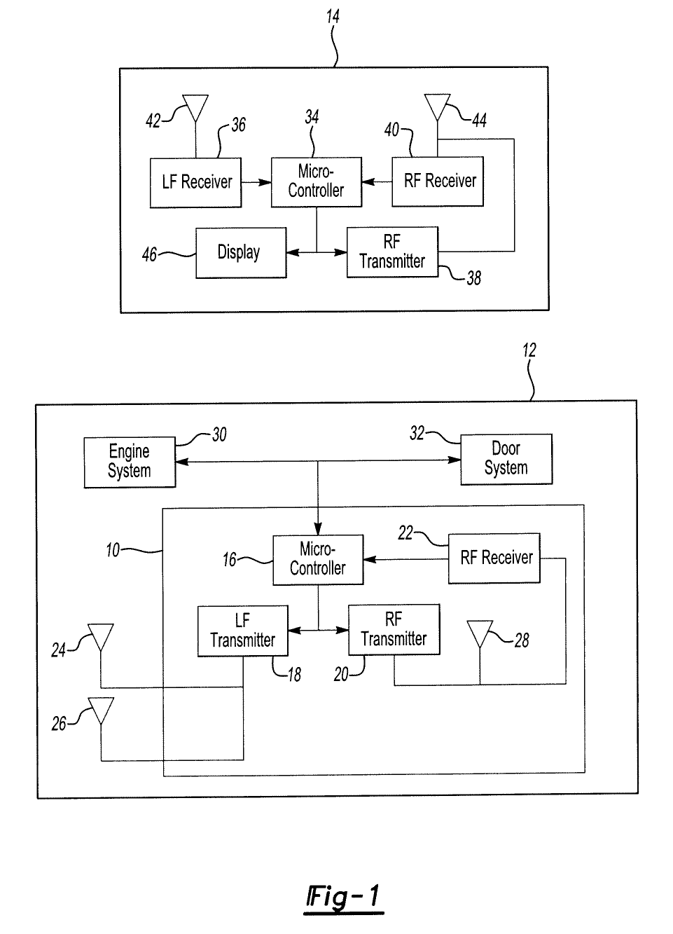

Referring now to FIG. 1, an embodiment of a PASE module 10 of an automotive vehicle 12 is configured to communicate with a token 14, e.g., a fob, card, etc. The PASE module 10 includes a micro-controller 16 electrically coupled with a low frequency transmitter 18, a high frequency transmitter 20, e.g., a radio frequency transmitter, and a high frequency receiver 22, e.g., a radio frequency receiver. The phrase “low frequency” typically refers to frequencies in the range of 3-300 KHz with a preferred frequency of 125 KHz. The phrase “high frequency” typically refers to frequencies in the range of 300 MHZ-3 GHz with a preferred frequency of 315 MHZ for North America and 434 MHZ for Europe. Other ranges, however, are also possible.

In the embodiment shown in FIG. 1, antennas 24, 26 are electrically coupled with the low frequency transmitter 18. The position of the antennas 24, 26 within the vehicle 12 is known by the micro-controller 16. For example, the antennas 24, 26 are respectively positioned near a driver's side door and passenger's side door (not shown) of the vehicle 12. As discussed below, this position information may be used by the micro-controller 16 to determine the location of the fob 14 relative to the antennas 24, 26. An antenna 28 is coupled with the radio frequency transmitter 20 and the radio frequency receiver 22. In other embodiments, additional antennas (as well as additional receivers and/or transmitters) may be positioned throughout the vehicle to monitor, for example, additional regions of the vehicle, such as a trunk.

The micro-controller 16 is also coupled with an engine system 30 and a door system 32. In other embodiments, the micro-controller 16 may be coupled with any suitable vehicle system to be controlled by the PASE module 10. For example, the micro-controller 16 may be electrically coupled with a lighting system or climate control system. The micro-controller 16 is configured to monitor and control the operation of the systems 30, 32. The micro-controller 16, for example, may determine a status associated with the systems 30, 32 by processing signals indicative of such status from the respective systems 30, 32. This status information may be sent to the fob 14 via the radio frequency transmitter 20. The micro-controller 16 may also lock and unlock the door system 32 in response to receiving suitable remote keyless entry commands.

In the embodiment of FIG. 1, the fob 14 includes a micro-controller 34 electrically coupled with a low frequency receiver 36, a high frequency transmitter 38, e.g., a radio frequency transmitter, and a high frequency receiver 40, e.g., a radio frequency receiver. An antenna 42 is electrically coupled with the low frequency receiver 36. An antenna 44 is electrically coupled with the radio frequency transmitter 38 and radio frequency receiver 40. In other embodiments, the fob 14 may include buttons (not shown) associated with remote keyless entry functions such as door locking/unlocking, panic alarm as well as others.

The low frequency receiver 36 of the fob 14 receives wake-up signals broadcast via the low frequency transmitter 18 of the PASE module 10. The wake-up signals prompt the micro-controller 34 to power-up from a low-power consumption mode in anticipation of further communications and in advance of executing further code.

The radio frequency receiver 40 of the fob 14 receives status messages broadcast via the radio frequency transmitter 20 of the PASE module 10. The status messages may include information regard the status of engine system 30 and/or door system 32. For example, the status messages may indicate that an engine (not shown) of the engine system 30 is off and a door (not shown) of the door system 32 is locked.

A display 46 is electrically coupled with the micro-controller 34. The micro-controller 34 processes the status messages and displays them via the display 46. The radio frequency receiver 40 is typically on while the display 46 is on.

An exemplary passive entry sequence begins, for example, when a door handle switch (not shown) of the door system 32 generates a triggering pulse. This triggering pulse is provided to the micro-controller 16. In response to the triggering pulse, the micro-controller 16 generates a trigger generation function. The low frequency transmitter 18 is activated to generate the low frequency wake-up signals, discussed above, associated with the trigger generation function. The low frequency wake-up signals are broadcast via the antennas 24, 26. The low frequency wake-up signals respectively broadcast by the antennas 24, 26 may include information indicative of the antenna from which it was broadcast.

The low frequency wake-up signals may be used to locate the fob 14 relative to the antennas 24, 26. In some embodiments, the low frequency receiver 36 includes any suitable circuitry (not shown) for measuring a received signal strength indicator (RSSI) of each of the low frequency wake-up signals. The micro-controller 34 includes the RSSI information in a response sent to the PASE module 10. The PASE module 10 determines which antenna is nearest the fob 14 based on the RSSI information. Locating the fob 14 relative to the antennas 24, 26 ensures that a user of the fob 14 is located in the area where the passive function is being requested. For example, locating the fob 14 relative to the antennas 24, 26 ensures that the user of the fob 14 is located outside the door system 32 when the door handle switch (not shown) is actuated.

Powering-up the fob 14 includes activating the radio frequency receiver 40 in anticipation of receiving an expected challenge signal from the PASE module 10 as part of any suitable challenge/response validation sequence. For example, the micro-controller 16 generates a random number to be used as a seed number in a mathematical transformation that is also known by the micro-controller 34. The radio frequency transmitter 20 broadcasts a challenge signal that includes information indicative of the random number. The radio frequency receiver 40 receives the challenge signal and provides it to the micro-controller 34. The micro-controller 34 applies the mathematical transformation to the random number. The transformed random number, as well as the RSSI information discussed above and a fob identifier, are included in a response sent to the PASE module 10. The micro-controller 16 may then check the fob identifier and the transformed random number to validate the fob 14.

As discussed above, electromagnetic noise associated with the display 46 when it is activated may affect the ability of the fob 14 to accurately measure the RSSI of the wake-up signals broadcast via the antennas 24, 26. If the display 46 is active when the low frequency wake-up signals are broadcast, the micro-controller 34 will ignore them, e.g., the micro-controller 34 will not measure the RSSI of the low frequency wake-up signals, the micro-controller 34 will not initiate a response to the low frequency wake-up signals, etc.

In some embodiments, upon receiving the low frequency wake-up signals, the micro-controller 34 will deactivate the display 46 and initiate a retry signal to prompt the micro-controller 16 to generate another low frequency wake-up signal. The retry signal is broadcast via the antenna 44. In other embodiments, upon receiving the subsequent challenge signal generated by the PASE module 10, the micro-controller 34 will deactivate the display 46 and initiate a retry signal to prompt the micro-controller 16 to generate another low frequency wake-up signal.

The micro-controller 16 will activate the low frequency transmitter 18 to generate another low frequency wake-up signal in response to receiving the retry signal. This low frequency wake-up signal is broadcast via the antennas 24, 26 and the wake-up process and challenge/response validation sequence continues as described above. The display 46 may then be re-activated. In some embodiments, particularly those in which the micro-controller 34 does not initiate a retry signal, the micro-controller 16 may activate the low frequency transmitter 18 to generate another low frequency wake-up signal a predetermined period of time, e.g., 20 milliseconds, after the low frequency wake-up signal is broadcast. The predetermined period of time, however, may depend on design considerations and latency requirements. Other configurations are also possible.

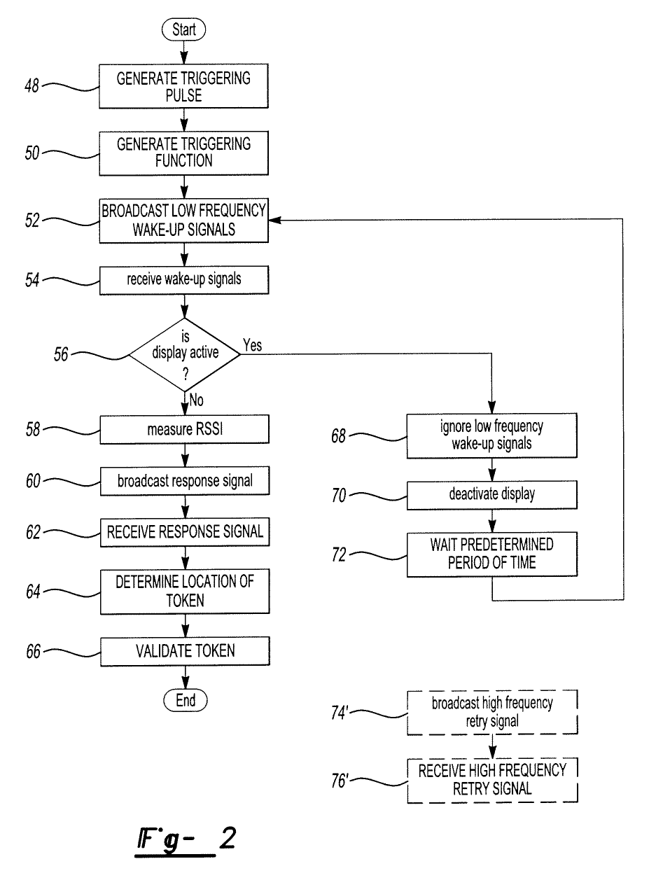

Referring now to FIG. 2, the steps depicted in upper case text are performed by a PASE module, such as the embodiment of the PASE module 10 of FIG. 1. The steps depicted in lower case text are performed by a token, such as the embodiment of the fob 14 of FIG. 1. The steps of FIG. 2 are depicted sequentially. Of course, certain of the steps may be performed in parallel. For example, the PASE module and token may perform certain of their steps in parallel.

A triggering pulse is generated in response to a PASE triggering event at step 48. At step 50, a triggering function is generated. At step 52, low frequency wake-up signals are broadcast. At step 54, the wake-up signals are received. A determination is made as to whether a display is active at step 56. If the display is not active, the RSSI of the wake-up signals is measured at step 58. At step 60, a response to the wake-up signals is broadcast. At step 62, the response signal is received. At step 64, the location of the token is determined based on information in the response signal. At step 66, the token is validated.

Returning to step 56, if the display is active, the wake-up signals are ignored at step 68. At step 70, the display is deactivated. That is, the display and its associated circuitry is deactivated. At step 72, a predetermined period of time is waited. The method then returns to step 52.

Alternatively, steps 74′ and 76′ may be performed instead of step 72. At step 74′, a high frequency retry signal is broadcast. At step 76′, the high frequency retry signal is received. The method then returns to step 52. Other strategies are, of course, also possible. For example, as discussed above, the token may deactivate the display in response to receiving a challenge signal as opposed to the wake-up signals. This strategy may be useful in circumstances where the wake-up signals may not be received by the token.

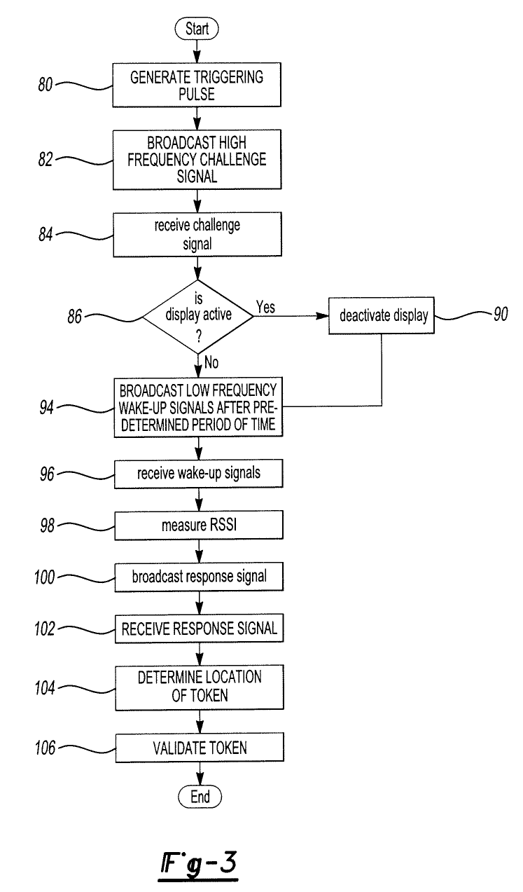

Referring now to FIG. 3, the steps depicted in upper case text are performed by a PASE module and the steps depicted in lower case text are performed by a token. As mentioned above, certain of the steps may be performed in parallel. A triggering pulse is generated in response to a PASE triggering event at step 80. At step 82, a high frequency challenge signal is broadcast. At step 84, the challenge signal is received. A determination is made as to whether a display is active at step 86. If the display is active, it is deactivated at step 90. At step 94, low frequency wake-up signals are broadcast a predetermined period of time, e.g., 20 milliseconds, after the high frequency challenge signal is broadcast. At step 96, the wake-up signals are received. At step 98, the RSSI of the wake-up signals is measured. At step 100, a response to the wake-up signals is broadcast. At step 102, the response signal is received. At step 104, the location of the token is determined based on information in the response signal. At step 106, the token is validated.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A passive entry system for an automotive vehicle comprising:
a control unit being configured to broadcast a wake-up signal at a first frequency to prompt a token to power-up if the token is in a low-power consumption mode; and
a token, including a display, being configured to receive the wake-up signal and to deactivate the display if the display is active in response to receiving the wake-up signal.

2. The system of claim 1 wherein the control unit is further configured to broadcast another wake-up signal at the first frequency if a reply to the wake-up signal is not received within a predetermined period of time.

3. The system of claim 1 wherein the token is further configured to ignore the wake-up signal if the display is active.

4. The system of claim 1 wherein the token is further configured to broadcast a retry signal after receiving the wake-up signal to prompt the control unit to broadcast another wake-up signal at the first frequency.

5. The system of claim 4 wherein the control unit is further configured to receive the retry signal and to broadcast another wake-up signal at the first frequency in response to receiving the retry signal.

6. The system of claim 5 wherein the token is further configured to re-activate the display after receiving the another wake-up signal.

7. The system of claim 6 wherein the token is further configured to measure a field strength of the another wake-up signal and to generate a response signal that includes information indicative of the measured field strength.

8. The system of claim 1 wherein the first frequency comprises a frequency in the range of 3 to 300 KHz and the second frequency comprises a frequency in the range of 300 MHZ to 3 GHz.

9. A method of operating a token of a passive entry system, the token including a display, the method comprising:
receiving a high frequency challenge signal to validate the token;
determining if the display is on; and
turning the display off in response to receiving the high frequency challenge signal if the display is on.

10. The method of claim 9 further comprising generating a retry signal to prompt a control unit to send a wake-up signal.

11. The method of claim 10 further comprising receiving the another wake-up signal.

12. The method of claim 11 further comprising turning the display on after receiving the another wake-up signal.

13. The method of claim 11 further comprising measuring a field strength of the another wake-up signal.

14. The method of claim 13 further comprising generating a response signal that includes information indicative of the measured field strength.

15. The method of claim 9 further comprising receiving a low frequency wake-up signal to prompt the token to power-up if the token is in a low-power consumption mode and ignoring the low frequency wake-up signal if the display is active.

16. A method of operating a passive entry system including a control module and token, the token including a display, the method comprising:
generating a display deactivation signal to prompt the token to deactivate the display; and
generating a wake-up signal to prompt the token to power-up if the token is in a low-power consumption mode.

17. The method of claim 16 further comprising generating another wake-up signal if a reply to the wake-up signal is not received within a predetermined period of time.

18. The method of claim 16 further comprising receiving a retry signal, generating another wake-up signal in response to receiving the retry signal, and receiving a response signal including information indicative of a measured field strength of the another wake-up signal.
